(19) United States
(12) Patent Application Publication
(10) Pub. No.: US 2023/0235681 A1
(43) Pub. Date: Jul. 27, 2023

(54) MODULAR NOZZLE RING FOR A TURBINE STAGE OF A CONTINUOUS FLOW MACHINE

(71) Applicant: TURBO SYSTEMS SWITZERLAND LTD., Baden (CH)

(72) Inventors: Joel SCHLIENGER, Zürich (CH); Martin THIELE, Zillis (CH); Rene METTLER, Untersiggenthal (CH)

(21) Appl. No.: 18/010,645

(22) PCT Filed: Jun. 21, 2021
(86) PCT No.: PCT/EP2021/066845

§ 371 Date: Dec. 15, 2022

(30) Foreign Application Priority Data
Jun. 23, 2020 (EP) 20181648.5

(51) Int. Cl. F01D 17/16

(52) U.S. Cl. CPC F01D 17/165

(57) ABSTRACT

The invention relates to a modular nozzle ring for a turbine stage of a continuous flow machine. The modular nozzle ring has a carrier system having an an adjustment ring, and a blade module having a blade leaf. The blade module is detachably connected to the carrier system. Furthermore, an adjustment angle of the blade leaf by the carrier system, in particular by the adjustment ring spaced apart from a flow channel, is specified, which adjustment angle is unchangeable during operation. The blade module is designed to be detachably pressed to a turbine housing part on the flow side, in particular by the adjustment ring. The invention furthermore relates to a blade module for a modular nozzle ring of a turbine stage and the use of a carrier system for a modular nozzle ring.

### TECHNICAL FIELD

The present invention relates to a modular nozzle ring for a turbine stage of a turbomachine, a vane module for a modular nozzle ring of a turbine stage and the use of a carrier system for a modular nozzle ring.

### BACKGROUND

For increasing power of an internal combustion engine, nowadays exhaust gas turbocharges are used as standard with a compressor which is arranged upstream of the engine, a common shaft and the turbine which is connected thereto in the exhaust gas line of the internal combustion engine. With the charging of an internal combustion engine, the air and fuel filling quantity and consequently the fuel admixture in the cylinders is increased and a perceptible increase in power for the engine is achieved therefrom. The exhaust gas turbocharger used therefor comprises as standard a rotor, comprising a compressor wheel, a turbine wheel and a connection shaft and the bearing, the flow-guiding housing portions (for example, the compressor housing and turbine housing) and the bearing housing located therebetween.

The power which is taken from the exhaust gas of the engine and which is important for driving a turbocharger is initially transmitted via a turbine wheel to the rotating shaft and then to the connected compressor wheel. Thus, air from the environment of the compressor can be drawn in, compressed and pressed into the cylinders of the engine at a high discharge pressure and with a high filling level. The power from the hot engine exhaust gas is obtained in technical flow terms by selective torsion removal in the turbine wheel and transmitted to the shaft. In the constructive embodiment of the turbine stage, nozzle rings are often inserted between the helical turbine housing and the turbine wheel in order to produce this torsion.

The nozzle ring usually comprises a plurality of flow profiles, so-called nozzle ring vanes, and produces by the fixed adjustment of a profile angle an operation-dependent torsion flow on the rotating turbine wheel which is located downstream. The significant property of the nozzle ring is adjusting the entry torsion into the turbine wheel by selecting the vane angle so that an ideal operation for the engine is enabled.

For each adjustment angle of the vane profiles, consequently, the surface-area of the channels subjected to flow and the specification of the nozzle ring and the flow speeds at the outlet of the nozzle ring also change. Consequently, the torsion removal in the rotating turbine wheel also changes at a predetermined entry mass flow and operating point of the engine. By selecting the specification of the nozzle ring, consequently, it is possible to adapt and adjust the operating behavior of the turbocharger to the requirements of the engine.

The nozzle rings are used at high exhaust gas temperatures of up to 700° C., in erosive media and at high flow speeds. In this case, high-value and usually expensive basic materials must be used in order to ensure a robustness of the nozzle ring during operation.

Generally, the nozzle rings are usually produced from cast steel and are subsequently processed to the final dimensions. Sometimes, the nozzle rings if the geometry allows it are also milled to dimension from the full block for a desired specification.

In the prior art, turbochargers which are adapted to the requirements of the engine are provided. The enormous variety of specifications leads to a high production and storage complexity and associated storage costs.

In view of what has been set out above, there is a need for an improved nozzle ring for a turbine stage which can be adapted particularly easily to the respective requirement of a turbocharger and/or an engine application.

### STATEMENT OF INVENTION

This object is at least partially achieved by a modular nozzle ring for a turbine stage of a turbomachine according to claim 1. Furthermore, the object is achieved by a vane module for a modular nozzle ring of a turbine stage according to claim 15 and by using a carrier system for a modular nozzle ring according to claim 16. Other embodiments, modifications and improvements will be appreciated from the following description and the appended claims.

According to one embodiment, a modular nozzle ring for a turbine stage of a turbomachine is provided. The modular nozzle ring has a carrier system having an adjustment ring and a vane module having a vane leaf. The vane module is releasably connected to the carrier system. An adjustment angle, which is particularly invariable during operation, of the vane leaf is fixed by the carrier system, in particular by the adjustment ring which is spaced apart from a flow channel. The vane module is further configured to be releasably pressed against a turbine housing portion which is at the flow side, in particular by the adjustment ring.

According to a general aspect, there is provision for the adjustment angle, which is desired for the respective use, of the vane leaf to be provided before assembly of the modular nozzle ring or before assembly of the turbine stage. Consequently, there is no provision for changing the adjustment angle of the vane leaf during operation. The modular nozzle ring can also be referred to as a modular fixed-geometry nozzle ring.

The modular nozzle ring allows the use of a high number of identical components, irrespective of the required specifications of the turbine stage. In particular, the vane module which is disclosed herein or nozzle ring vane module is provided as an identical component. Components of the carrier system, typically only the adjustment ring, are individually produced for the adjustment angle desired for the respective application.

The modular nozzle ring which is disclosed herein allows the nozzle ring specification to be fixed directly before assembly, that is to say, for example, only on the date of assembly. It is thereby possible to prevent the problem of long procurement times. The frequently required great variety of specifications with respect to different adjustment angles can be achieved by a range of adjustment rings which are specific to the desired adjustment angles being kept in store. High storage costs can be substantially reduced because according to the present disclosures only identical components and a set of specifically produced adjustment rings are stored. Generally, approximately up to 20 different vane adjustment angles are required for a specific size of a turbine stage. In the case of cast nozzle rings which are conventional in the prior art, that is to say, with non-releasable, fixed nozzle ring geometries, typically a large range of nozzle rings is stored in order to be able to comply with the readiness for rapid delivery in the event of an order being placed. If a large range is not kept in store, long delivery times result. For this reason, in the prior art very many nozzle ring specifications are kept in store in large quantities and variants beforehand. In addition to high storage costs for the nozzle rings, a dependence on potentially long throughput times and unreliable delivery chains are also connected with this.

Advantageously, the model costs for the nozzle ring according to the embodiments disclosed herein can be reduced because only the adjustment ring is varied specifically for the desired adjustment angle. In the prior art, a very high investment expenditure is produced for the model costs for the enormous quantity of different variants of nozzle rings.

The modular nozzle ring is configured to be releasably secured to the turbine stage. The carrier system can, for example, be inserted or clamped in a housing portion of the turbine stage. The vane module is releasably connected to the carrier system. Furthermore, the vane module is configured to be releasably pressed against a flow-side turbine housing portion. The modular nozzle ring disclosed herein is consequently able to be disassembled. For example, in the case of possible wear of the vane module, the modular nozzle ring can be removed from the turbine stage, the worn vane module can be replaced and the turbine stage can subsequently be re-assembled. A damaged vane module can be readily replaced in the case of servicing by a new vane module and the existing nozzle ring and all the other components of the turbine stage can continue to be used. In cast nozzle rings which are conventional in the prior art, a complete replacement of the nozzle ring is necessary in the case of wear.

The vane module defines a longitudinal axis starting from one end of the vane leaf toward a baseplate of the vane module. The term “at the flow side” indicates a direction along the longitudinal axis and is intended to be understood to mean a direction facing a flow channel or, in the case of a plurality, the primary flow channel. The term “bearing side” indicates a direction which is substantially counter to the flow-side space along the longitudinal axis.

The vane module has the vane leaf at a flow-side end portion. The orientation of the vane leaf defines the adjustment angle of the vane module and therefore of the modular nozzle ring inside the turbine stage. At the bearing side of the vane leaf, the vane module has the baseplate. The baseplate is typically constructed to be cylindrical and planar (that is to say, it has a small extent along the longitudinal axis). The baseplate can be configured to form a closure or, in other words, a housing wall portion, of the (primary) flow channel. The vane module can have a seal which is connected to the baseplate or which is integrated in the baseplate, for example, lamellar sealing rings. The sealing ring can seal the baseplate radially in order to seal the (primary) flow channel from the end at the bearing side of the baseplate.

In one embodiment, the vane module has at the bearing side of the base plate a vane shaft which extends axially (along the longitudinal axis). The vane shaft is substantially arranged axially centrally and typically extends over a portion of the cross section of the baseplate.

The adjustment ring of the carrier system can have a vane shaft opening. The vane shaft opening has an extent which corresponds at least to the cross section of the vane shaft. The vane shaft opening of the adjustment ring is configured to guide through the vane shaft of the vane module. A bearing-side end portion of the vane shaft can be arranged at least partially in the vane shaft opening of the adjustment ring. Typically, a bearing-side end of the vane shaft projects out of the adjustment ring at the bearing side.

The vane shaft can allow the vane module to be secured to the adjustment ring in such a manner that the bearing-side end of the vane shaft which projects at the bearing side out of the vane shaft opening of the adjustment ring is retained by the adjustment ring at the bearing side and is impeded from passing through the vane shaft opening of the adjustment ring.

The modular nozzle ring and in particular the carrier system can have a securing element. The securing element can be releasably connected to the end of the vane shaft at the bearing end. In this case, a cross section of the securing element can be greater than a cross section of the vane shaft opening of the adjustment ring or alternatively can have a geometry which prevents the securing element from passing through the vane shaft opening at the flow side. Consequently, the vane shaft, and therefore the entire vane module, is prevented from “falling out” in a flow-side direction. At the same time, the vane module is axially movable in a bearing-side direction.

Typically, the securing element is a securing ring, for example, a snap ring or retention ring. The bearing-side end portion of the vane shaft may be configured in a cylindrical manner and/or the vane shaft opening may be configured in a circular manner. The diameter of the securing ring may be greater in this instance than the diameter of the vane shaft opening. Alternatively, for example, the securing element can also be a securing pin or a securing needle. In another embodiment, the securing element is a nut, wherein the bearing-side end of the vane shaft has an axially limited thread.

The bearing-side end of the vane shaft can have a securing groove. The securing element, in particular the securing ring, can be arranged in the securing groove. The securing element, in particular the securing ring, can be releasably connected to the securing groove in a positive-locking manner.

In one embodiment, the securing element is a screw. The bearing-side end of the vane shaft may have an internal thread. In this embodiment, the vane shaft typically does not extend out of the adjustment ring at the bearing side. The screw can be screwed into the vane shaft with axial play in such a manner that the vane module and the adjustment ring can be clamped/pressed by a clamping element which is described below.

The vane shaft is further used, in addition to securing the vane module by means of the securing element, to guide and stabilize and therefore to hold together different components of the modular nozzle ring (such as, for example, a clamping element which is described below).

In one embodiment, the vane module has a support structure which extends axially (along the longitudinal axis) at the bearing side of the baseplate. The support structure is arranged on a radial end portion of the vane module and can extend as far as the radial end of the vane module. The support structure can extend over a partial circumference or also over the entire circumference of the vane module. The support structure may have a plurality of support struts. In one embodiment, the support structure has two support struts. In the case of two support struts, the support struts can be arranged at approximately 180° relative to each other, that is to say, approximately at opposite radial end portions of the vane module. Other angles are also possible, however.

The external face(s) of the support structure, that is to say, at the radial end of the vane module, may be configured in a cylindrical manner. The external face(s) of the support structure can have substantially the same shape as the baseplate, but is/are in many embodiments tapered with respect to the baseplate. A cross section of the external face of the support structure can consequently be smaller than the cross section of the baseplate. The internal face(s) of the support structure is/are preferably arranged with spacing from the vane shaft. Between the support structure and the vane shaft there is arranged a gap or empty space which preferably extends over the entire circumference of the vane shaft.

According to one embodiment, the vane module has at an end on the bearing at least one, typically at least two, connection element(s). The at least one connection element is arranged at the end of the support structure on the bearing. In the case of a plurality of connection elements, the support structure may have the corresponding number of support struts, wherein one of the connection elements can be arranged at the end of one of the support struts on the bearing.

The adjustment ring further has at least one groove, preferably at least two grooves. In this case, the at least one groove may be in the form of a notch. Preferably, however, the groove is an axially continuous opening. The adjustment angle of the vane leaf is fixed to the adjustment ring by a releasable connection between the at least one connection element and the at least one groove. In relation to the adjustment angle, that is to say, the degree of freedom of rotation, the connection may be considered to be positive-locking.

The groove can be dimensioned in accordance with the connection element. In particular, the groove may have a shape which corresponds to the cross-section of the connection element and/or may have a slightly greater cross section than the connection element. A “play” is thereby minimized with respect to the adjustment angle. In an exemplary embodiment, the connection element is in the form of a cam.

In one embodiment, the vane module has a first and a second connection element. The adjustment ring has a first and a second groove per vane module. The connection elements and/or the grooves are arranged or configured in this case in such a manner that only a predefined connection or installation position and therefore a predefined adjustment angle is possible.

In one exemplary embodiment, the connection elements and the grooves of the respective support structures are not arranged opposite each other (that is to say, at an angle different from 180°, for example 130°).

In another exemplary embodiment, the first and second grooves and/or the first and second connection elements have different cross sections (cross section sizes) and/or different cross sectional shapes (circular, rectangular, etc.). In this case, the first connection element can be dimensioned in accordance with the first groove and the second connection element can be dimensioned in accordance with the second groove. The term “dimensioned in accordance with” is intended to be understood to mean in this case that the groove and connection element have a comparable cross section and/or a comparable cross sectional shape (circular, rectangular, etc.). At the same time, the first and second connection elements can have different cross sections and/or the first and second grooves can have different cross sections.

In an exemplary embodiment, the vane module has the first and second connection elements. The first and second connection elements are arranged approximately opposite each other and are each in the form of a cam. In this case, the first cam has a greater extent along one side than the second cam. The first and second grooves are configured in accordance with the first and second cams.

In the case of three or more connection elements and grooves, the same applies accordingly. The connection elements and grooves are arranged or configured in such a manner that only a predefined connection or installation position and therefore a predefined adjustment angle is possible. The provision of two or more connection elements increases the mechanical stability of the modular nozzle ring.

The adjustment ring can be produced specifically for the desired adjustment angle of the vane leaf. In one embodiment, the adjustment ring has a planar, cylindrical shape. Furthermore, the adjustment ring can have a vane shaft opening and at least one, preferably at least two, groove(s) which are spaced apart from the vane shaft opening per vane module.

The desired adjustment angle of the vane leaf can be predetermined by the positioning of the at least one groove. Modular nozzle rings according to the present disclosure allow the nozzle ring specification to be determined only on the date of assembly, wherein only one stored range of adjustment rings is required for conventionally used vane adjustment angles. The connection between the groove and the connection element is usually not fixed permanently (for example, by a materially engaging connection). In the event of maintenance, therefore, a damaged vane module can readily be removed and replaced by a new vane module.

According to one embodiment, the vane module is configured to be releasably pressed against a flow-side turbine housing portion by the carrier system, in particular the adjustment ring. Preferably, the vane module is configured to be pressed against the flow-side turbine housing portion in a resilient manner.

According to one embodiment, the modular nozzle ring has a clamping element. The clamping element can, for example, be a clamping spring or a disk spring. The clamping element is configured to act counter to the carrier system, in particular the adjustment ring.

A resilient pressing of the vane module against the flow-side turbine housing portion can be carried out by the clamping element acting counter to the carrier system and the carrier system pressing the vane module against the flow-side turbine housing portion (by an indirection action of the clamping element on the vane module).

Preferably, the clamping element is configured to act counter to the carrier system, in particular the adjustment ring, and the vane module. It is thereby possible to carry out a force transmission from the carrier system, in particular the adjustment ring, to the clamping element and from the clamping element to the vane module.

The clamping element can be arranged between the adjustment ring and the baseplate and/or can be arranged inside the gap or empty space which is formed between the support structure and the vane shaft. In this case, the clamping element can be arranged concentrically around the vane shaft and/or concentrically inside the support structure. The vane shaft and/or the support structure prevent possible sliding of the clamping element. The clamping element can be supported against the bearing-side end of the baseplate of the vane module. Alternatively, an intermediate portion can also be arranged between the clamping element and the baseplate.

In one embodiment, the clamping element is configured to axially press the vane module, in particular by the clamping element being supported against the baseplate of the vane module, against the flow-side turbine housing portion. The pressing can be carried out against a support face or a channel contour of the flow-side turbine housing portion. The flow-side end of the vane leaf can be axially clamped on the channel contour of the turbine housing portion on contact. The clamping element consequently acts as a compression spring. The clamping element is configured to press the vane module against the flow-side turbine housing portion without gaps. A gap between the flow-side end of the vane leaf and the channel contour of the turbine housing portion is thereby prevented, which can lead to an improvement of the turbine stage effectiveness level.

The clamping element can further be configured to axially press the adjustment ring against a bearing-side housing portion of the turbomachine. The clamping element can be supported against a flow-side support face of the adjustment ring. The support face can in this case be arranged between the vane shaft opening and the at least one groove. Alternatively, an intermediate portion can also be arranged between the clamping element and the support face of the adjustment ring. The bearing-side end of the adjustment ring can be clamped axially on a support face or a counter-contour of the bearing-side housing portion on contact.

As a result of the resilient pressing of the vane leaf against the flow-side turbine housing portion, and in particular the pretensioning between the clamping element and the adjustment ring and the clamping element and baseplate, the components of the modular nozzle ring are axially clamped and are thus secured during operation with respect to vibration forces. This pretensioning of the components reduces the risk of oscillating friction wear at the connection faces between the components of the nozzle ring and the housing, whereby a long service-life is enabled and a possible failure of the nozzle ring construction is intended to be prevented.

The carrier system can further have a carrier ring. The carrier ring is configured to receive the adjustment ring. The carrier ring can have at a bearing end a circular recess or notch, in which the adjustment ring is inserted. Consequently, the adjustment ring is arranged at the bearing side of the carrier ring. The carrier ring can be configured to prevent a movement of the adjustment ring in a flow-side direction. The carrier ring is typically not configured to prevent a bearing-side movement of the adjustment ring. The carrier ring can further have a heat shield or a heat layer.

The carrier ring can have an axially extended opening, in which the vane module is partially inserted. In particular, the opening of the carrier ring acts as a receiving member for the support structure and/or the vane shaft. The opening of the carrier ring can further serve to guide the support structure. Advantageously, the opening can have to this end a slightly greater cross section than the external face of the support structure. The carrier ring can also act at least partially as a receiving member for the baseplate. For example, the opening may be of cylindrical form. The opening of the carrier ring can have a cross sectional shape which corresponds to the baseplate.

One side of the carrier ring can face the (primary) flow channel. A portion of the side facing the flow channel can, particularly together with the baseplate, form a closure or in other words a housing wall portion, of the (primary) flow channel. The seal which is connected to the baseplate or which is integrated in the baseplate is configured to seal the baseplate at the bearing-side end or a radial end with respect to the carrier ring. The adjustment ring is arranged with spacing from the flow channel or is not or not substantially subjected to the primary flow. The clamping element, the support structure and the vane shaft are not or not substantially subjected to the main flow. The carrier ring can be configured to be axially clamped between the housing portion on the bearing and the flow-side turbine housing portion. The carrier ring can be produced as an identical component, irrespective of a desired adjustment angle.

According to one embodiment, the opening of the carrier ring has a first cross section at the flow-side end of the opening which is at least as large as or slightly larger than the cross section of the baseplate. At the bearing side of the flow-side end of the opening, that is to say, from a flow-side end portion of the opening as far as a bearing-side end of the opening, the opening has a second cross section. Typically, the opening tapers from the first cross section to the second cross section in a stepped manner or in other words the opening can have a shoulder. The second cross section of the opening can be smaller than the cross section of the baseplate. At the same time, the second cross section can be slightly larger than the cross section of the external face of the support structure. In one embodiment, the opening of the carrier ring and the base plate each have a cylindrical shape. The opening tapers in a stepped manner from the flow-side end from a first diameter at the flow-side end to a smaller second diameter at the bearing side. The second diameter is smaller than the diameter of the baseplate.

Consequently, the opening can act as a receiving member and can serve to guide the support structure. Furthermore, the second cross section limits the freedom of movement of the baseplate in a bearing-side direction. In conclusion, the carrier ring can be configured to be axially clamped between the bearing-side housing portion and the flow-side turbine housing portion, and to limit the movement of the adjustment ring in a flow-side direction and optionally to limit the movement of the baseplate and therefore of the vane module in a bearing-side direction. The assembly comprising the adjustment ring and the vane module consequently has a given “axial play” in the assembled state between the housing portions, but can be limited by the carrier ring. Advantageously, the safety is thereby increased and the assembly of the modular carrier ring is thereby simplified. The assembly comprising the adjustment ring and the vane module can be axially clamped by using a clamping element. Furthermore, by using the securing element which is connected to the vane shaft, the vane module can be prevented from “falling out” of the adjustment ring at the flow side.

In an alternative embodiment, the opening of the carrier ring can also be a through-opening with a constant cross section or diameter in an axial direction, in particular without any shoulder. In this case, for example, the vane leaf can have a greater cross section or a greater width than the opening and/or the baseplate. A movement of the vane module in a bearing-side direction can thereby be limited.

In addition to already mentioned advantages, the presently disclosed modular nozzle ring can allow a simpler and more cost-effective production with respect to the prior art, particularly in comparison with cast nozzle rings.

As explained above, the vane module can be used for all the adjustment angles in an identical form and can consequently be produced as an identical component. The vane leaf, the vane shaft, the baseplate and the support structure can be constructed integrally or in one piece. In particular, the entire vane module can be constructed integrally. The vane module can be obtained by means of a metal powder injection molding method. Advantageously, following a metal powder injection molding method no subsequent processing on the vane module is necessary. Consequently, a vane module which is suitable for an application can be obtained directly by a metal powder injection molding method. It is thereby possible to keep the production and component costs for the modular nozzle ring very low.

The adjustment ring can be provided as a blank, for example, made from a highly heat-resistant and thermally stable metal sheet in the form of a ring, can be configured with a predetermined thickness and can be kept in store in the as-yet unprocessed state and at low cost. The at least one groove can be incorporated in the blank after an adjustment angle has been determined. Alternatively, a range of adjustment rings for a large number of adjustment angles can be prepared for subsequent assembly and kept in store. The grooves of the adjustment ring can, for example, be obtained via laser cutting or water-jet cutting. In particular, the water-jet method can be implemented in a simple and cost-effective manner.

The clamping element, in particular the clamping spring, is produced from a thermally stable material. The securing element, in particular the securing ring, is also produced from a thermally stable material.

According to one embodiment, the modular nozzle ring has a large number or an assembly of vane modules. Each of the vane modules is releasably connected to the carrier system, in particular the adjustment ring. The adjustment ring can have a vane shaft opening and at least one groove per vane module. Furthermore, the modular nozzle ring has a clamping element for each vane module. In each of the vane modules, the clamping element acts counter to the carrier system, in particular the adjustment ring. Furthermore, the carrier ring can have an opening for each of the vane modules.

According to one embodiment, a turbine stage of a turbomachine, in particular for a turbocharger or a power turbine, is provided. The turbine stage has a modular nozzle ring according to one of the embodiments disclosed herein. The turbine stage further has a turbine wheel and a turbine housing or helix. Optionally, the turbine stage has an outlet diffusor in an outlet region. The modular nozzle ring can be arranged between the turbine housing (helix) and the turbine wheel. The vane shaft and/or the vane leaf is/are orientated in the direction of the rotor axis of the turbine wheel. The components of the turbine stage can be produced as identical components, irrespective of a desired adjustment angle (with the exception of the above-mentioned adjustment ring), in particular the turbine housing and a turbine wheel can be in the form of identical components.

The turbine stage can have the bearing-side housing portion and/or the flow-side turbine housing portion. The bearing-side housing portion can form a first flow wall or hub-side flow wall for the (primary) flow channel together with the baseplate and/or the carrier ring. The flow-side turbine housing portion which is arranged for releasably pressing the vane module forms a second flow wall for the (primary) flow channel. The second flow wall is arranged opposite the first flow wall.

The turbine stage can further be configured for a bearing-side incoming gas flow. The bearing-side incoming gas flow allows a flow of gas at the bearing side of the baseplate. It is thereby also possible to obtain a gas pressure which is similar to or higher with the (primary) flow channel at the bearing side of the baseplate. The bearing-side incoming gas flow allows a decrease in mechanical stress and thereby an increase in the service-life of the components of the modular nozzle ring, in particular the clamping element. The bearing-side housing portion may have an opening which is connected to a gas connection. The bearing-side incoming gas flow can be provided by means of an air purge system which is at the compressor side from the compressor stage or by means of an air purge system which is intended to be connected externally. In another embodiment, the vane module is further configured to be releasably pressed against a flow-side turbine housing portion by means of an air purge system.

The turbine stage can be mounted by inserting the modular nozzle ring and the turbine wheel into the bearing-side housing portion, subsequently placing the flow-side turbine housing portion and axially clamping the housing portions. The turbine stage is configured to axially compress the modular nozzle ring by axially clamping the bearing-side housing portion and the flow-side turbine housing portion. The axial compression in conjunction with the clamping element allows a gapless pressing of the vane module against the flow-side turbine housing portion.

According to an embodiment, a vane module is provided for a modular nozzle ring of a turbine stage. The vane module can have each of the features of the vane module disclosed above in conjunction with the modular nozzle ring. A number of the aspects are summarized below.

The vane module has a vane leaf and at least one connection element which is arranged at a bearing-side end, in particular a cam. The connection element is configured to fix an adjustment angle of the vane leaf by means of a connection between the connection element and a groove of a carrier system, in particular an adjustment ring of the carrier system, of the modular nozzle ring.

The vane module, in particular the vane leaf, is configured to releasably press against a flow-side turbine housing portion. Preferably, the vane leaf is configured to resiliently press against a flow-side turbine housing portion.

In one embodiment, the vane module has an axially extended vane shaft at the bearing side of a baseplate of the vane module. The vane shaft is arranged substantially axially centrally and typically extends over a portion of the cross section of the baseplate. A bearing-side end portion of the vane shaft can be configured to be guided at least partially through and into a vane shaft opening of the adjustment ring and/or a bearing-side end of the vane shaft can be configured to project from the adjustment ring at the bearing side.

The vane shaft can be configured to be secured to the adjustment ring, in particular by means of a securing element. The bearing-side end of the vane shaft can have a securing groove for receiving and/or fixing a securing element.

In one embodiment, the vane module has an axially extended (along the longitudinal axis) support structure at the bearing side of the baseplate. The support structure is arranged at a radial end portion of the vane module and can extend as far as the radial end of the shaft module. The support structure can extend over a partial circumference or also over the entire circumference of the vane module. The support structure can have a plurality of support struts. Typically, the support structure has two support struts. In the case of two support struts, the support struts are preferably arranged at approximately 180° relative to each other, that is to say, approximately at opposite radial end portions of the vane module. Other angles are also possible, however.

An internal face(s) of the support structure is/are preferably arranged with spacing from the vane shaft. Between the support structure and the vane shaft, there is arranged a gap or empty space which extends preferably over the entire circumference of the vane shaft. The gap or empty space can be configured to receive a clamping element.

The at least one connection element is arranged at the bearing-side end of the support structure. In the case of a plurality of connection elements, the support structure can have the corresponding number of support struts, wherein one of the connection elements can be arranged at the bearing-side end of one of the support struts.

According to one embodiment, the use of a carrier system for a modular nozzle ring is provided. The carrier system can have any of the features of the carrier system which is disclosed above in connection with the modular nozzle ring. The carrier system has an adjustment ring and in particular a carrier ring.

### BRIEF DESCRIPTION OF THE FIGURES

The invention is explained in greater detail below with reference to embodiments without the embodiments being intended to limit the scope of protection defined by the claims.

The appended drawings depict embodiments and are used together with the description to explain the principles of the invention. The elements of the drawings are not necessarily true-to-scale relative to each other. Identical reference numerals indicate correspondingly similar components.

In the Figures:

FIG. 1 shows a portion of a modular nozzle ring according to one embodiment.

FIG. 2 shows a portion of a modular nozzle ring according to one embodiment.

FIG. 3 shows a vane module for a modular nozzle ring according to one embodiment.

FIG. 4 shows a portion of a carrier system according to one embodiment.

FIG. 5 shows a portion of a modular nozzle ring according to one embodiment.

FIG. 6 shows a portion of a modular nozzle ring according to one embodiment.

FIG. 7 shows a portion of a modular nozzle ring according to one embodiment.

FIG. 8 shows a portion of a carrier system according to one embodiment.

FIG. 9 shows a portion of a modular nozzle ring according to one embodiment.

FIG. 10 shows a portion of a modular nozzle ring according to one embodiment.

FIG. 11 shows a portion of a modular nozzle ring according to one embodiment.

FIG. 12 shows a portion of a modular nozzle ring according to one embodiment.

### EMBODIMENTS

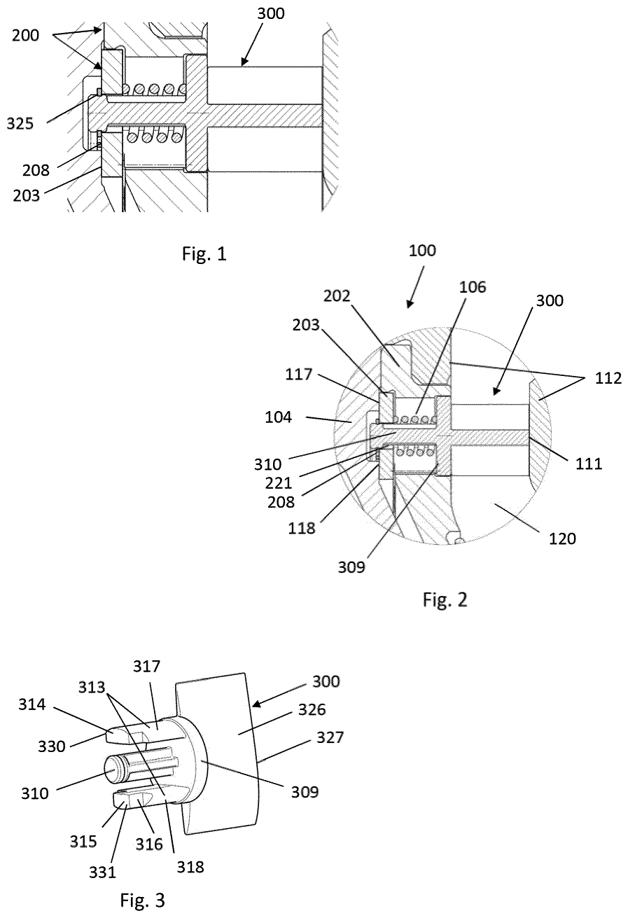

FIG. 1 shows a portion of a modular nozzle ring 100 for a turbine stage of a turbomachine. The modular nozzle ring is illustrated in a turbine stage in the fitted state. The modular nozzle ring 100 has a vane module 300 and a carrier system 200.

One embodiment of the vane module 300 is shown separately in FIG. 3 (not fitted in the modular nozzle ring 100). The vane module 300 has the vane leaf 326 at a flow-side end portion. At the bearing side of the vane leaf 326, the vane module 300 has a baseplate 309. The baseplate 309 is typically configured to form a closure or, in other words, a housing wall portion, of the (primary) flow channel 120. At the bearing side of the baseplate 309, the vane module 300 has a lateral, axially extended support structure 313. The support structure 313 can have a plurality of support struts 317, 318. The vane module 300 shown in FIG. 3 has, for example, two support struts 317, 318 which are arranged at approximately 180° relative to each other, that is to say, approximately at opposite radial end portions of the vane module 300.

Two connection elements 330, 331 are arranged at the bearing-side end of the support structure 313 or of the two support struts 317, 318. The connection elements which are shown in FIG. 3 are in the form of a cam. The two cams 330, 331 have a similar cross sectional shape, but have a different cross section (or cross sectional size) 314, 315. The different cross sections 314, 315 allow a clear determination of an adjustment angle α of the vane leaf 326 and prevent, for example, the vane module from being able to be fixed to the carrier system 200 in a state rotated through 180° and the vane profile angle from thereby being incorrectly adjusted or the vane leaf from being orientated in an incorrect manner relative to the flow direction.

Adjustment faces 316 (only one is marked in FIG. 3) are arranged at the side of the bearing-side ends 314, 315 of the cams. The adjustment faces 316 are configured to move into contact with the grooves of the adjustment ring (described below) in order to determine an adjustment angle.

The vane module 300 further has a vane shaft 310. The vane shaft 310 extends from the baseplate 309 as far as a bearing-side end of the vane module 300. The vane shaft 310 is substantially axial and can further be arranged centrally. A securing groove 325 is arranged at a bearing-side end portion of the vane shaft 310. The securing groove 325 is not marked in FIG. 3 and can best be seen in FIG. 1.

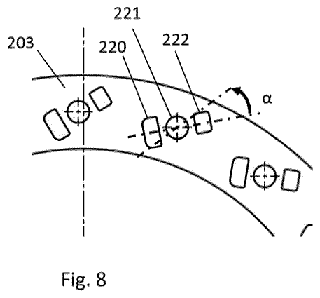

The carrier system comprises an adjustment ring 203. A portion of the adjustment ring 203 is separately shown in FIG. 8 (not fitted in the modular nozzle ring 100).

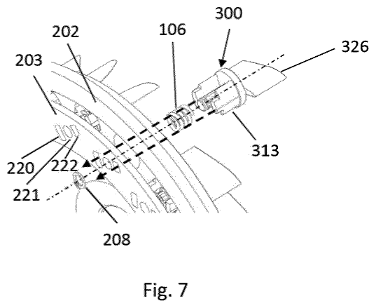

The adjustment ring 203 has for each vane module 300 a vane shaft opening 221 for receiving the vane shaft 310. The vane module 300 can be secured to the vane shaft 310. The modular nozzle ring 100 has a securing element 208. The securing element 208 may, for example, be a securing ring 208, as clearly shown in FIGS. 7 and 9. The securing element 208 is releasably connected to the bearing-side end of the vane shaft 310, in particular the securing ring 208 is releasably connected to the securing groove 325 in a positive-locking manner. The securing element 208 prevents the vane module 300 from “sliding out” of the adjustment ring 203 at the flow side.

The adjustment ring 203 has for each vane module 300 at least one groove 220, 222 for fixing the adjustment angle α of the vane leaf 326. The adjustment angle α is fixed by a connection between the precise cam 330, 331 of the vane module and the groove 220, 222, which has corresponding and precise dimensions, of the adjustment ring 203. The adjustment faces 316 of the cams 330, 331 come into contact with the grooves 220, 222 at both sides. The cams 330, 331 and grooves 220, 222 which are configured with different cross sections ensure the correct installation position of the vane module 300 and only one installation position is therefore possible.

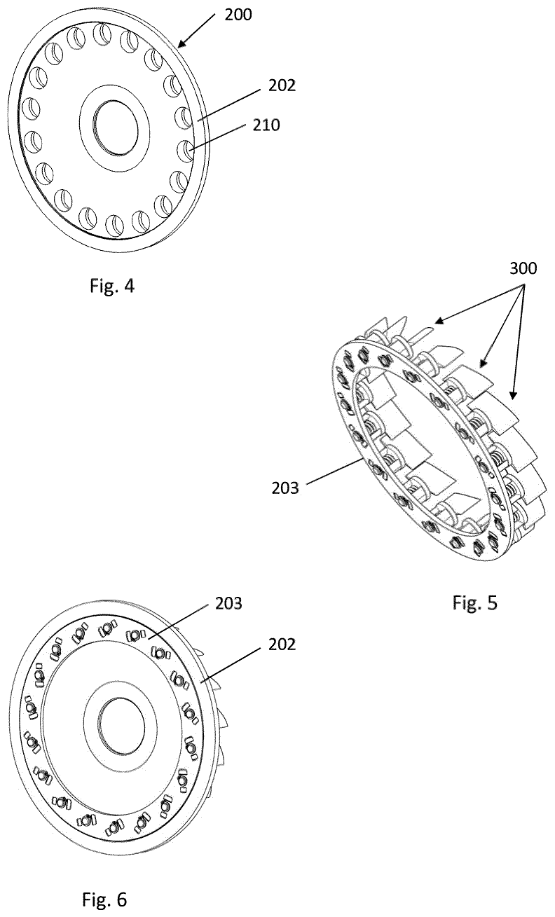

In addition, the carrier system may have a carrier ring 202 which can be seen only partially in FIG. 1. FIG. 2 shows a greater view of the modular nozzle ring 100 from FIG. 1. The carrier ring 202 is configured to receive the adjustment ring 203. At an end at the bearing side, the carrier ring 202 has a circular recess in which the adjustment ring 203 is inserted. The bearing-side end of the carrier ring 202 and the circular recess can be seen, for example, in FIG. 4. The adjustment ring 203 can be inserted in the carrier ring 202 in this case without being fixed to the carrier ring 202. The carrier ring 202 has a large number of openings 210 which are used to receive the vane modules 300 (only one of the openings 210 is marked in FIG. 4). In this case, the vane can be reliably guided through with cylindrically configured external faces of the support structure 313 in the opening 210 of the carrier ring 202 and inside a remaining radial residual gap.

The carrier ring 202 further has a central opening for receiving a turbine wheel or a shaft. The carrier ring 202 is fixed by a housing portion 104 at the bearing side, as can be seen, for example, in FIGS. 1 and 2. Additionally, the carrier ring 202 can also be axially clamped between the bearing-side housing portion 104 and a flow-side turbine housing portion 112.

The modular nozzle ring can further comprise a clamping element 106. For example, FIGS. 1 and 2 show as embodiments of the clamping element a clamping spring 106. The clamping element 106 is configured to act counter to the adjustment ring 203 and the vane module 300. A force transmission from the carrier system 200, in particular the adjustment ring 203, to the clamping element 106 and from the clamping element 106 to the vane module 300 can thereby be brought about.

The clamping element 106 is arranged between the adjustment ring 203 and the baseplate 309 and/or arranged inside the gap or empty space which is formed between the support structure 313 and the vane shaft 310. The clamping element 106 is supported against the bearing-side end of the baseplate 309 of the vane module 300. The clamping element 106 is further supported against a flow-side support face of the adjustment ring 203.

FIG. 5 shows the assembly comprising the adjustment ring 203 and a large number of vane modules 300. The vane modules 300 are in this case fixed at the adjustment angles α by the connection to the grooves and secured by means of the securing elements 208. The clamping element 106 leads to a clamping in the assembly comprising the adjustment ring 203 and the vane modules 300.

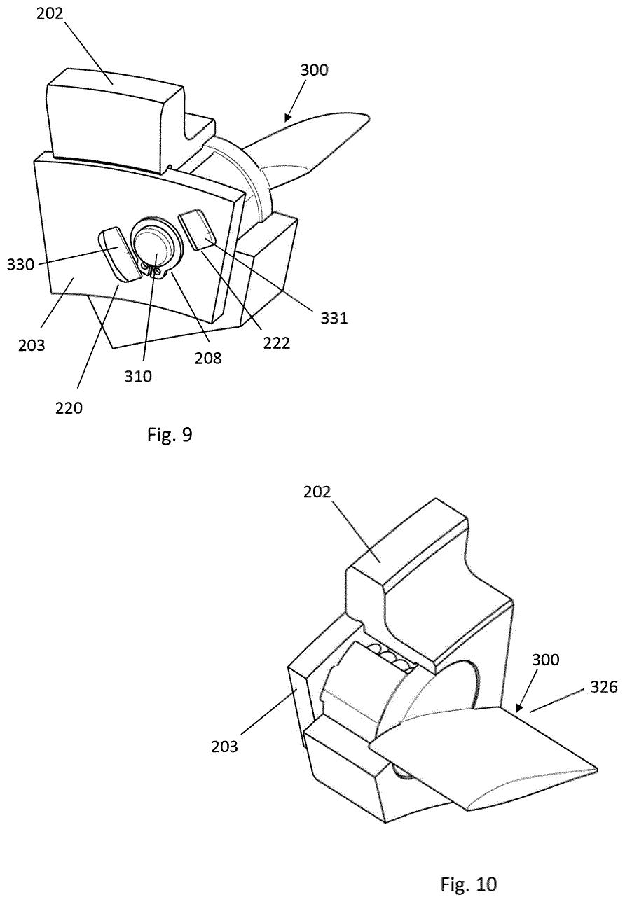

FIG. 6 shows a combination of FIGS. 4 and 5, that is to say, the combination of the carrier ring 202, adjustment ring 203 and a large number of vane modules 300. A cutout of this assembly is shown in FIGS. 9 and 10 for a vane module 300.

FIG. 7 shows a cutout from FIG. 6 as an exploded illustration. The narrow dot-dash line illustrates the longitudinal axis and the two bold arrows indicate the bearing-side direction along the longitudinal axis.

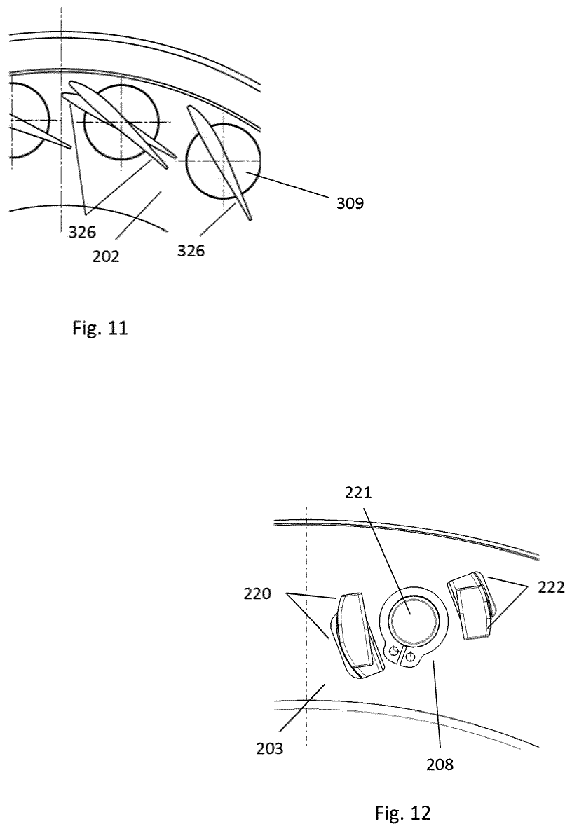

FIG. 8 shows the adjustment ring 203 and the grooves 220, 222 which are contained therein and the vane shaft opening 221. FIG. 8 additionally indicates two different angle positions of the adjustment angle α by the two dot-dash lines. The vane shaft opening 221 can be configured identically for all the adjustment angles α. The position of the grooves 220, 222 requires an adaptation to the desired adjustment angle α. FIG. 11 also indicates the changes at different adjustment angles at the central vane module shown and in particular the differently arranged vane leaf 326. FIG. 12 shows a cutout of a rear view from FIG. 11. By way of example, the positions of the grooves 220, 222 are shown for two different adjustment angles α.

As illustrated, for example, in FIGS. 1 and 2, the modular nozzle ring 100 is fitted between the flow-side turbine housing portion 112 and the bearing-side housing portion 104 of the turbomachine. The bearing-side housing portion 104 can have a recess for receiving the vane shaft 310 which projects out of the adjustment ring 203 at the bearing side.

The axial spacing between the flow-side turbine housing portion 112 and the bearing-side housing portion 104 is configured to be shorter in this case than the axial spacing between the bearing-side end of the adjustment ring 203 and the flow-side end 327 of the vane leaf 326. The modular nozzle ring 100 is axially compressed by the assembly, whereby the load on the securing elements 208 is axially decreased and the adjustment ring 203 and the vane leaf 326 are each pressed against the housing portion.

The bearing-side end of the adjustment ring 203 is configured to be pressed against the counter-contour 117, 118 of the bearing-side housing portion 104. The flow-side end 327 of the vane leaf 326 is configured to be pressed against the channel contour 111 of the flow-side turbine housing portion 112.

The modular nozzle ring 100 is consequently axially clamped in the context of the configured resilient force. As a result of the resilient pressing, and in particular the pretensioning, the components of the modular nozzle ring 100 are axially clamped and are thus secured during operation with respect to vibration forces which involve wear. This pretensioning of the components reduces the risk of oscillating friction wear at the connection faces between the components of the nozzle ring and the housing, whereby a long service-life is enabled and a possible failure of the nozzle ring construction is prevented.

Although specific embodiments have been illustrated and described herein, it is within the scope of the present invention to combine or to modify the embodiments shown in a suitable manner without departing from the scope of protection of the present invention.

### LIST OF REFERENCE NUMERALS

100 Modular nozzle ring

104 Bearing-side housing portion

106 Clamping element

111 Channel contour (of the flow-side turbine housing portion)

112 Flow-side turbine housing portion

117, 118 Counter-contour of the bearing-side housing portion

120 Flow channel

200 Carrier system

202 Carrier ring

203 Adjustment ring

208 Securing element

210 Axially extended opening of the carrier ring

220 First groove

221 Vane shaft opening

222 Second groove

300 Vane module

309 Baseplate

310 Vane shaft

313 Support structure

314, 315 Bearing-side ends of the connection elements or cams

316 Adjustment faces

317, 318 Support struts

325 Securing groove

326 Vane leaf

327 Flow-side end of the vane leaf

330 First connection element or first cam

331 Second connection element or second cam

1. A modular nozzle ring for a turbine stage of a turbomachine having:
a carrier system having an adjustment ring; and
a vane module having a vane leaf,
wherein the vane module is releasably connected to the carrier system;
wherein an adjustment angle (α) of the vane leaf is fixed by the carrier system; and
wherein the vane module is configured to be releasably pressed resiliently against a flow-side turbine housing portion.

2. The modular nozzle ring as claimed in claim 1, wherein the vane module has an axially extended vane shaft, and
wherein the adjustment ring has a vane shaft opening,
wherein a bearing-side end portion of the vane shaft is at least partially arranged in the vane shaft opening of the adjustment ring.

3. The modular nozzle ring of claim 1, further having a clamping element which is configured to act counter to the vane module and the carrier system.

4. The modular nozzle ring as claimed in claim 3, wherein the clamping element is configured to axially press the vane module against the flow-side turbine housing portion.

5. The modular nozzle ring as claimed in claim 3, wherein the clamping element is arranged between the adjustment ring and the baseplate.

6. The modular nozzle ring as claimed in claim 3, wherein the clamping element is further configured to axially press the adjustment ring against a bearing-side housing portion of the turbomachine.

7. The modular nozzle ring of claim 1, further having a securing element which is releasably connected to the bearing-side end of the vane shaft.

8. The modular nozzle ring of claim 1, wherein the vane module has at a bearing-side end at least one connection element and the adjustment ring has at least one groove,
wherein the adjustment angle (α) of the vane leaf is releasably fixed by a connection between the at least one connection element and the at least one groove.

9. The modular nozzle ring of claim 1, wherein the vane module has a first and a second connection element, and the adjustment ring has a first and a second groove, and
wherein the first connection element is dimensioned in accordance with the first groove and
wherein the second connection element is dimensioned in accordance with the second groove.

10. The modular nozzle ring of claim 1, wherein the vane module has a support structure which is arranged at the bearing side of the baseplate and at a radial end portion of the vane module, wherein the at least one connection element is arranged at the bearing-side end of the support.

11. The modular nozzle ring of claim 1, wherein the carrier system further has a carrier ring, wherein the carrier ring has an axially extended opening which is configured to receive the support structure and/or the vane shaft; and/or further having a large number of vane modules, wherein each of the vane modules is releasably connected to the carrier system.

12. The modular nozzle ring of claim 1, wherein the vane leaf, the vane shaft, the baseplate and the support structure are integrally constructed.

13. The modular nozzle ring of claim 1, wherein the vane module is further configured to be releasably pressed against a flow-side turbine housing portion by means of an air purge system.

14. The turbine stage of a turbomachine, having a modular nozzle ring of claim 1.

15. A vane module for a modular nozzle ring of a turbine stage, the vane module having:
a vane leaf, and
at least one connection element which is arranged at a bearing-side end and which is configured to fix an adjustment angle (α) of the vane leaf by means of a connection between the connection element and a groove of a carrier system of the modular nozzle ring; and
wherein the vane module is configured to resiliently, releasably press against a flow-side turbine housing portion.

16. The carrier system for a modular nozzle ring of claim 1, having an adjustment ring;
wherein the adjustment ring has a vane shaft opening; and
wherein the adjustment ring has a first and a second groove; and
wherein the first and second grooves have different cross sections.

17. The modular nozzle ring of claim 1, wherein the adjustment angle (α) is invariable during operation.

18. The modular nozzle ring of claim 1, wherein the adjustment angle (α) of the vane leaf is fixed by the adjustment ring which is spaced apart from a flow channel.

19. The modular nozzle ring of claim 1, wherein the vane module is configured to be releasably pressed resiliently by the adjustment ring against a flow-side turbine housing portion.
